(19) United States
(12) Patent Application Publication
(10) Pub. No.: US 2015/0310457 A1
(43) Pub. Date: Oct. 29, 2015

(54) User managed method for capturing and pricing data items to develop a salable digital persona

(71) Applicant: Stanley Smith, Charlotte, NC (US)

(72) Inventor: Stanley Smith, Charlotte, NC (US)

(73) Assignee: Stanley Benjamin Smith, Charlotte, NC (US)

(21) Appl. No.: 14/265,311

(22) Filed: Apr. 29, 2014

(51) Int. Cl. G06Q 30/02

(52) U.S. Cl. CPC G06Q 30/0201

(57) ABSTRACT

A method for a user to capture, configure, store, link, exchange, and set trading parameters (prices and other exchange values) for data drawn from the user's personal data file combined with other user generated data; including data resulting from the user's interactions with file creation software, data items generated from user interactions with electronic devices and components, and data automatically generated by electronic components and devices owned by a user. In combination, these combined data sources coupled with a personal data file form a digital persona or a “digital doppelganger” that may be traded or sold or retained as private in a data marketplace.

This application is a continuation in part of Ser. No. 14/048,012 and claims priority and benefit of US application filed Oct. 7, 2013 entitled “User controlled system and method for collecting pricing and trading data” which is hereby incorporated by reference in its entirety.

### DESCRIPTION OF THE RELATED ART AND BACKGROUND OF THE INVENTION

Historically, usable electronic information required information to be converted into data strings that were then processed through relatively rigid formatting conventions. Documents, spreadsheets, databases, html variants for websites, presentations, Computer assisted drawings (CAD), and so forth operated upon data within a software package or a user selected set of executable computer coded instructions. The generator of the data had to pre-determine which format would be applied to the data and how it might be converted to a usable data item or field by opening an executable program on an electronic device that would act upon the data according to the operational functions and structure of the executable program. A user had to anticipate the function, purpose, or use of data and invoke relevant executable code to process it. Data formatting options are now more flexible.

Systems and methods to capture user interaction with electronic devices through a variety of sensors and other data capture devices, such as video cameras and audio recorders are rapidly evolving. Data captured in the form of chemical signatures, light waves, pressure on a display screen, and so forth can be converted into various data formats and used for pattern recognition, data visualization, data extraction, and other data processing functions. It has become increasingly useful to consider the capture and processing of data as a series of “data items” that can be processed in the flexible fashion taught in prior art by Smith (U.S. Pat. No. 7,860,760) upon his introduction of a data supply chain. A data supply chain is a set of data items which can be repurposed and reconfigured for posting into any of a multiplicity of file formats according to criteria acceptable to an owner of the data item. In this art, the owner of the data item allocates the data item to be processed by computer readable code or by an algorithm that evaluates the inherent structure or nature of the data item and automates assignment and configuration of it into a format that can be included into a data store.

The invention described herein introduces a method to convert data resulting from a user's interaction with an electronic device into an “interactive variable” that is then converted into a “captured data item” that can be allocated to a data store and trading parameters or prices configured as taught in prior art for a data supply chain. Computer readable code is now readily available to automatically evaluate and classify user interaction with electronic devices (interactive variables) and convert these to electronic information through the application of translation algorithms and then convert the electronic information to one or more data items. At the point electronic information is converted to a data item, additional computer readable code can be invoked to process and classify the data item according to further user determined actions or by further automated operations. A data item, upon placement into a database, is often called a data field. However, the invention does not require every data item to be placed into a database. The term data store is used to indicate either a database or a memory cache or a temporary or transient string of computer readable characters accessible in electronic or electromagnetic form. A variant of this kind of processing is illustrated by the functions and operations of what is commonly referred to as “machine intelligence.”

Technological advances in the processing of data also enable a different way of thinking about pricing or valuing a data item for purchase, sale, or exchange. Rather than the customary view of the value of data being determined by its location and position in a dataset or a database, the unit to be priced or traded can now be a single data item or data items paired with one or more other data items, provided these carry sufficient attributes, properties, and links to descriptive information to enable them to be properly evaluated by a prospective buyer. The value of a unit of information configured as a data item may vary. In aggregate and over time, a volume of data items can accumulate significant value. Data items are particularly valuable if they can be readily structured to be processed by analytic engines and applied to marketing and research processes. The art introduced by Smith (U.S. Pat. No. 8,612,307) regarding a Data Item Pair (a question and an answer) and art introduced by Smith to capture a data entry field and pair it with a response entered into a data collection format also may increase in value due to timeliness or immediacy. When a data item changes, it becomes “news” that might be “actionable” and can be used to trigger forward and backward chains of server actions. A data item may also increase in value in proportion to the necessary and sufficient context linked to or associated with it, enabling it to be allocated to multiple processes according to the context attributes and associations it carries. Thus, real time generation, capture, classification, and enrichment of information converted to data items with sufficient context offers terrific potential for targeted and specific uses, such as risk management and focused marketing.

Personal data has value to commercial enterprises that desire to re-purpose and leverage the data to enable more targeted and effective advertising, more targeted and effective product development and design, operational decisions, and other uses aimed at increasing their market share, easing their research burdens, and facilitating their responsiveness to market trends and shifts. In Ser. No. 14/048,012 of which this application is a continuation in part, art for a user directed and managed accumulation of data into a structured saleable format of a “personal data file” has been taught. The method for developing a personal data file includes capturing, ordering, assigning and storing data entry field labels captured via a user interacting with his electronic device along with entries into data entry fields as the user interacts with executable files on his devices, with the internet, and with electronic devices of other users. These intentional entries or responses to data collection formats—often demographic, opinion, or survey data—results in a personal data file of data entry field labels coupled with data entries made into the associated data entry fields. The resulting personal data file is itself is a saleable product. The invention disclosed herein enhances and expands a personal data file by including data items captured through user interaction with sensors and other electronic devices and components able to capture user behavior. Thus, both the interactional data fields and the data items in the personal data file are enriched and reified.

One of advantages of structured databases, tabular datasets, and spreadsheets has been to enable labelling and attribution of data along with a clear chain of custody for the data. Provision of context for data that is not encased in a software application enables opportunities and constraints for interpreting it. Sufficient context also increases the value of data, especially if it is separated from traditional formats. It may be defensible to claim that the value of information convertible to a data item is dependent upon associated variables such as the origin, quality, specificity, timeliness, and “anticipated importance” it carries.

As will become evident in the description of the art that follows; a link to data items resulting from “in process” user interactions as the user interacts with sensors and other peripheral equipment associated with the user's electronic device or an electronic device of a trading partner, if coupled to or linked to a personal data file as taught by Smith in Ser. No. 14/048,012, will enable the owner of the electronic device and peripheral electronic sensors or components to retain the value of data resulting from interactions in a digital or pervasive or ubiquitous computing environment. Thus, data generated by individual users of electronic devices and/or by user interactions with components or peripheral devices linked to an individual user can be captured, priced or valued via trade parameters, collated, and traded according to the individual user's decisions and choices to include the data into his subset of the “data supply chain.” A combination of a personal data file, a user's intentionally created files using file creation software, data resulting from a user's interactions with the digital environment, and the bio-electro-mechanical data resulting from automatically generated data from electronic devices and sensors owned by or accessible to the user is what might be termed a “digital doppelganger” or a digital persona.

The advent of the internet of things has also generated a plethora of communications, usually in the form of SMS or email alerts from peripheral electronic sensors and components to the owner of the sensor or component. This is not a new capability, but the number of alerts and notifications is increasing exponentially as the internet of things takes hold and expands. In light of the need to enrich the context associated with electronic information as much as is reasonable, the invention teaches art to enable an identification attribute or descriptive label to be attached to captured electronic information as it is converted into a data item by the user and a priority level to be attached to the data item. The priority level establishes the sequence and the timing (scheduling) of processes that are implemented upon a change to a data item if it is changed or updated and an alert is transmitted by the peripheral electronic sensor or component.

While many priority level assignments for alerts are possible, the primary issues in a priority assignment are whether an alert is to be ignored, automatically responded to by computer readable code on the device receiving the alert, or pushed to the owner or user of the device receiving the alert for the owner or user to 108 consciously react or respond to the alert. Priority assignment can also require additional layers of response within an organizational hierarchy or additional classes of responses depending on the configuration of the alert and the conditions that were met when the alert was generated.

The invention disclosed herein is one approach to empowering an individual data creator to allocate information generated through interaction with their electronic devices, sensors, and peripheral devices to be converted to data items and placed into a data store. The individual data creator can then attach a label drawn from already extant labels in his personal data file (as taught by Ser. No. 14/048,012) in a data store accessible to him or generate a label to assign to the data item, thus creating a data item pair or a tagged data item. The individual data creator can also designate a priority for his data items and designate which processing classes (as taught by Ser. No. 14/048,012) for his data items he wants to apply; such as be retained as private, be packaged for sale within a data marketplace, and voluntarily contributed or exchanged with another entity participating in a data supply chain. It teaches an effective system and method for including and folding interactive data and files built by a data creator into his personal data store, organizing that data, and structuring the sale and exchange of that data. The data trade or exchange can be done intermittently or in real time.

There are three classes of information or data originating as “interactive variables” that are convertible to “captured data items” included within the method of the invention, all connected to a fourth class that has been described in Ser. No. 14/048,012:

The first class of information is that which results from the user's intentional interaction with his electronic device to create rigorously formatted files, such as a spreadsheet, a document, a database, a presentation, and a drawing. These are commonly already structured into in the form of tradable files of one or many data items. The computer software generated data files, such as a “Word” document or a “Database” are the most commonly traded form of this data.

The second class of information is the user's interaction with his electronic or digital environment, usually on devices possessed by the user. These data items are comprised of the user's gestures captured by motion tracking peripherals, the user's selection of pixels on a display screen or icons on a display screen, the user's voice commands, or the user's chemical profile or blood pressure or heart rate or any of the myriad of data points that can be captured by sensors or peripheral devices that participate in what is now called the internet of things or the pervasive computing environment. These have not been commonly traded, but accrue value in the context of other classes of data items.

The third class of data items are those generated by sensors and electronic components associated with an individual, but not intentionally or consciously generated by the individual's interaction. Rather, these are generated by the sensors or electronic components interacting with each other autonomously or interacting with the environment. A thermostat in a home is a good example of this class of data. A useful perspective on this class of data is that it is electronic data generated as a surrogate for the owner of the device. The owner of the device has delegated the collection of the data item to the “agent” that is the sensor or electronic component. These data items also have not been commonly traded, but accrue value in the context of other classes of data items and the personal data file of their owner.

The fourth class of data items are those included into a “personal data file” as taught in Ser. No. 14/048,012. This art teaches the capture, processing and trading of data items generated by the user's interaction with electronic devices that are ordinarily not in his possession, but accessed through the Internet or some other electronic link. These are “transactional” data items such as demographic and other personal descriptors and responses entered into data collection or entry fields.

When these four classes of data are viewed in aggregate, they become the digital persona or the “digital doppelganger” of the user. Combinations of data items extracted from a digital persona have value and are tradable and exchangeable. The art that follows supplements methods already developed for the data supply chain and is intended to be used in tandem with other data supply chain systems and methods.

### SUMMARY OF THE INVENTION

The art introduced by the invention under consideration herein is a method for a user to capture, configure, store, link, exchange, and establish trading parameters (prices and other exchange values) for data drawn from the user's personal data file with other data; including data files resulting from the user's interactions with file creation software, data items generated from user interactions with electronic devices and components, and data automatically generated by electronic components and devices owned by a user. In combination, these combined data sources coupled with a personal data file form a “digital doppelganger” that is a product in its own right that may be traded or sold or retained as private in a free and open data trading marketplace.

Electronic devices have evolved to enable users to interact with them in multiple ways. An owner of an electronic device may now interact with more than a keyboard and a mouse. The owner might interact with one or more touch screens, cameras, video recorders, audio recorders, chemical sensors, electromagnetic sensors, location sensors, and pressure sensors, for example. Each interaction contributes to and enriches the digital portrait or “footprint” of a user. What is customarily considered “content” that is generated and produced by a user, such as a document or a presentation, is fundamentally a record of user interaction with their keyboard and mouse posted to a file following processing by electronic code operating upon the data captured from the user's interaction. For purposes of the invention taught herein, these are “artifacts” or “interactive variables” generated by user interaction with an electronic device that are part of the “digital persona” or “digital doppelganger” of the user of the invention. Interaction of the user of the invention with sensors and other data capture and transmission tools or equipment, directly through the user's interaction or indirectly through a intervening data capture and transmission tools, such as a smart card or a charge card or a single device connected to the internet of things is also “content;” and these may also be processed and converted into “captured data items” that further contribute to and comprise the user's digital doppelganger.

The invention is a further step to evolve an open and transparent personal data trading marketplace or exchange where private property and privacy are respected and data creators are rewarded for data they generate themselves or data generated by and through devices they own. The simplest way to describe the invention is . . . “data generated by electronic devices, peripheral devices, and electronic components associated with an identifiable user is captured and converted into data items, linked to categories and classes of data within the user's personal data file, and folded into the data supply chain with sufficient context to enable a potential buyer to assess the value of the data items.”

While the description of the art discusses a user as if the user is a person, any entity or device able to electronically perform the assignment functions described in the art and the claims through an automated link to a classification and assignment engine can function as a first user. For example, a server configured to link to other electronic devices and sensors can function as a user. Thus any entity participating in a pervasive or ubiquitous computing environment can be a user.

One added value resulting from appending bio-electro-mechanical user data to a personal data file is that it enables a buyer of the personal data file to evaluate user interaction with systems or services provided by the buyer. This can increase the efficacy of targeted marketing and advertising. A second added value is for health care providers who buy the data to mine the data for changes in heart rate, steadiness of hand, etc., as part of a process for early health warning systems and processes. A third benefit or added value will enable a data buyer identify correlations between user interests and habits as the users interact with their systems. Added value for the buyer resulting from appending structured software created user files is the ability of the buyer to correlate demographic data drawn from the personal data file and bio-electro-mechanical user data with user interactions with systems and services offered or provided by the buyer of the data.

### BRIEF DESCRIPTION OF THE DRAWINGS

Other aspects, features, and advantages of the present invention will become more fully apparent from the following detailed description, the appended claims, and the accompanying drawings in which:

FIG. 1 “Diagram of event sequences—data item capture, assignment, trade parameters, transmission to trading partner, revision of terms” describes operations as a set of sequences and is followed by an illustration of further sequences in FIG. 2.

FIG. 2 “Diagram of event sequences: 2 party authentication, download, transmission method, assignment to content domains and processing classes, adjust configuration, alternate devices” completes the illustration of sequences initiated in FIG. 1.

### DESCRIPTION OF THE INVENTION

This invention enriches the art in U.S. application Ser. No. 14/048,012, the invention of which it is a continuation in part; and claims priority and benefit of U.S. application Ser. No. 14/048,012. In this continuation in part of Ser. No. 14/048,012, the invention described herein enables the user to manage four varieties or classes of data items or sets of data items derived from interaction with electronic devices.

The first is the variable set of intentional interactions of the user with an electronic device that computer readable code transforms into data items for inclusion into files such as documents, spreadsheets, databases, presentations, and drawings as a user interacts with an electronic device. The data items are collated and collected and otherwise processed through a file creation software product. These are typically the products of user interactions—interactive variables—with a keyboard and/or a mouse within “office suites” that are themselves file creation software products such as MS Office, OpenOffice, and Libre Office. Intentional user interactions—interactive variables—with a keyboard and other peripheral entry tools are captured and processed into files that carry clear attributions of ownership and creation dates and other metadata about the file.

The second kind of interactive variable is those interactions that inform a data item or set of data items captured in the course of a user interacting with an electronic device under his control without a predetermined objective of creating a data file. This bio-electro-mechanical user data includes gestures, eye movements, chemicals (such as odors), digital and other pressure, sensed heart rates, sensed blood pressure, speed of movement of an object through space, differential light intensity and other electromagnetic spectrum intensity, and a myriad other data points can be captured by sensors or peripheral devices attached to electronic devices participating in a pervasive computing environment as part of the “internet of things.” If these interactive variables are associated with a user of an electronic device, they become part of the digital persona of the user just as much as documents and other data that are intentionally produced by the user.

The third kind of interactive variable results from a sensor or peripheral electronic device configured to generate data associated with the user due to the user's ownership relationship, but not requiring the user to interact with the device. Rather, the device or sensor may interact with environmental variables to capture data like ambient temperature, detect smoke or carbon dioxide, and so forth. Typically these devices are registered to a user, but perform autonomously; tying the data they produce to the registered user as if they were an extension or agent of the user. The term “agent derived interactive variable” is suggested for this type of captured data.

These first three variants or classes of information derived from interactive variables and converted to data items or sets of data items have little value in isolation. It is context that gives them value and utility. The personal data file as taught by Smith in Ser. No. 14/048,012 captures the fourth variant or class of interactive variable that provides the context that enables assignment of a value to the data items or sets of data items. These are the logins, passwords, authentication routines, demographic data, medical data, financial data, and other data that can be input directly into a personal data file by a user, but are more commonly captured through user interaction with remote servers or websites or devices as the user responds to data entry fields or surveys or medical or financial information requests.

For a prospective purchaser of data, necessary and sufficient context is crucial to determining value. The content category and the processing class of the data items drawn from a personal data file as in Ser. No. 14/048,012 coupled with the three variants or classes of data items or sets of data items derived from interactive variables provide the necessary and sufficient context for a prospective purchaser of a data item to determine a value or trade parameter. The user generating the set of data items can apply processing classes and pricing and valuation options from his personal data file to other classes of data items—his intentionally created files of data items processed and structured by file creation software; his interactive bio-electro-mechanical user data generated by his personal interaction with electronic devices or components; and data items generated by components or devices he owns. A user or a surrogate computer algorithm standing in for the user of the invention assigns a trade parameter to a data item as the data item is posted to a data store. Once the initial trade parameter has been set, it can be changed or adjusted according to or responsive to user determined decisions based on intervening variables that can impact the user's perception of value for trade or sale or exchange.

The art being taught is a method to shape and process four major categories or classes of data items into saleable configurations so these can be valued and traded in an open market. The personal data in the data file as in Ser. No. 14/048,012 is saleable as an independent set. While files created though programs may be saleable independently of the creator of the file, if they do not carry sufficient personal data regarding their creator, determining their value becomes arbitrary. An example is the reputational value assigned to works of “famous” artists versus works of arguably similar quality of new or developing artists. It is an advantage to data buyer to be able to determine the “reputation” of a contributor of a data item or a data file. If the owner of a personal data file can attach sufficient demographic data extracted from his personal data file to data items or data files he is offering for sale, a prospective buyer can make a more rational and context rich decision about the value of the data. Value for a data item outside of a traditional file structure can be even more variable, and “context” from a personal data file becomes even more crucial to determining value.

Art taught in the invention considers a “price” or a value to be one of many possible value exchanges, including a monetary value, a coupon for a product, a coupon for a service, a right to access and use a service of a second user, a right to access and use physical equipment owned by a second user, a right to view data in a data store of a second user, a right to download data from a data store of a second user, and a right to download a file from an electronic device of a second user. In a data supply chain economy, payment amounts can be micro-payments or large payments. The operable variables are the nature, structure, method, and processes implemented through the data exchange and the terms agreed to by the seller and buyer of the data items.

It is expected that many types and classes of users will be buyers and sellers of a data item. Typical users are marketing and sales entities, consumers, users of a social network, data federators, data aggregators, or institutions—particularly businesses and institutions focused on research. It is also expected that the number of and types of data items captured and posted into memory on an electronic device will vary widely. The creation of a link between information derived from an interactive variable of a user with an electronic device or electronic devices owned by a user and converted to a captured data item associated with a content category and processing class within a personal data file can be accomplished in many ways and it is not the province of this art to teach computer coding architecture or methods. However, it is important to note that the link or association of an interactive variable converted to a captured data item and posted to a memory or a data store and linked to a personal data file can be a one to one, one to many, or a many to one linkage. The captured data item linked to a data item within a personal data file makes it practical to fold these paired items parsimoniously into a data supply chain and increases the granularity and flexibility of data trading.

The definition of a buyer and a seller also includes the seller acting as a donor of data and the buyer as a recipient of a donation. It is not essential that fees be exchanged; rather both parties can be involved in an exchange that includes social and emotional rewards. Charities might well be able to monetize aggregated data donated by their supporters.

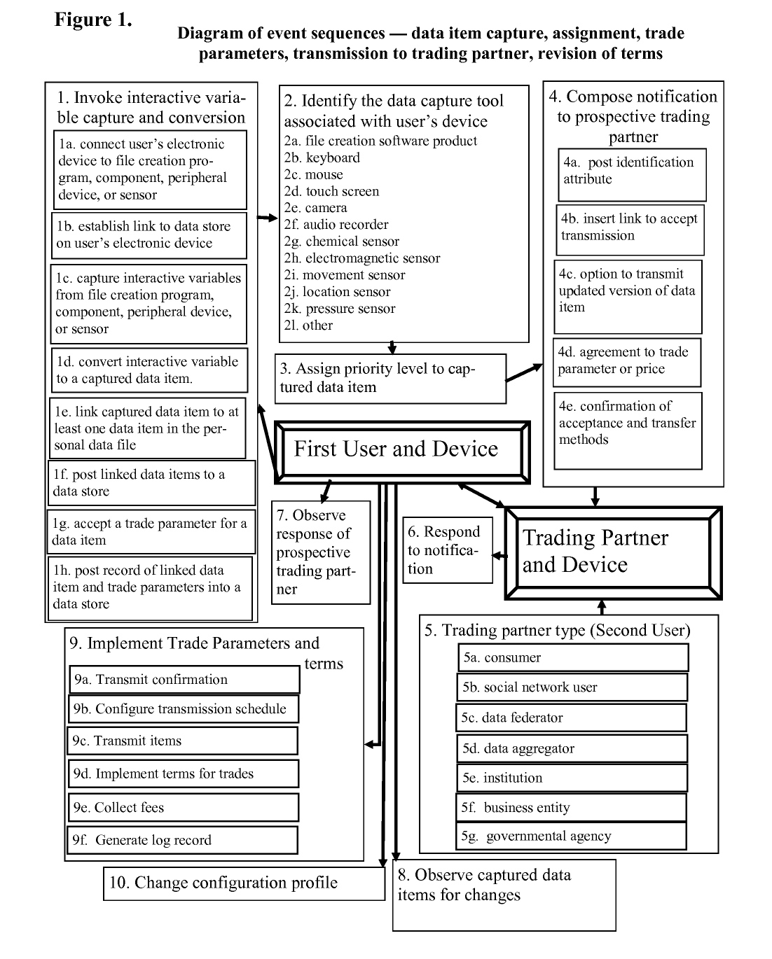

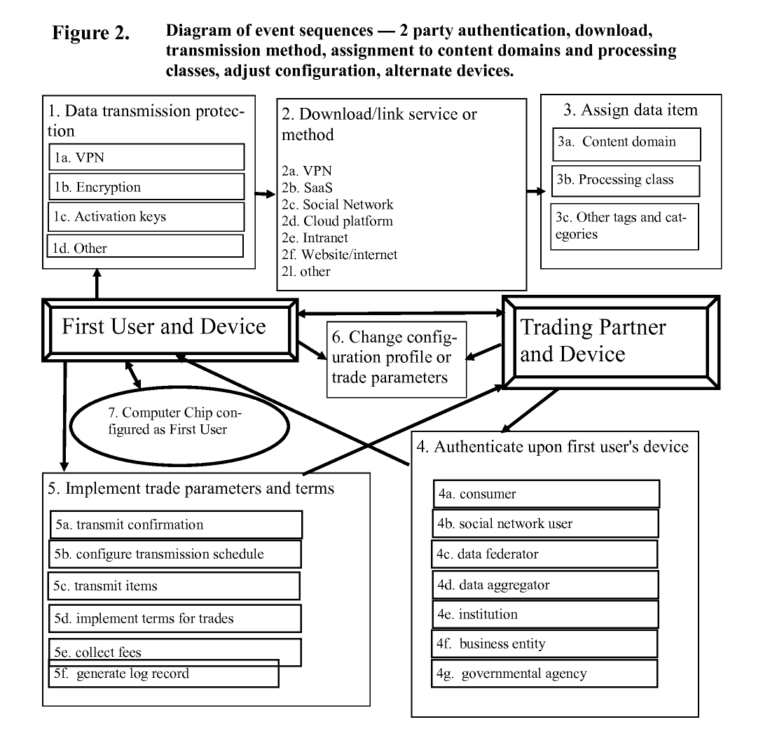

### Detailed Explanation of FIGS. 1 and 2 for Exemplary Embodiments of the Invention.

One skilled in the art of the invention will expect that the order and arrangement of the various components of the invention might vary according to some or all of the following variables: tools or equipment enabling a user to interact with an electronic device, the type of electronic device or server, software used for file creation, sensors and other equipment that are part of the “internet of things,” algorithms comprised of computer readable code to process configure catalog assign and post data to a data store, and remotely accessible websites and servers that implement computer readable code to post accept and process user interaction.

The method of the art includes a user invoking computer readable code to capture interactive variables, convert these to data items, attribute ownership of the data times, categorize the data items, set the trade parameters or price for the data items, and link and post the data items to a memory cache or a data store—as the user operates an accessible electronic device. An automated algorithm implemented through code on the device, or the user himself, can invoke additional segments or strings of computer readable code to convert captured interactive variables into data items and retain them in a computer readable format for posting to a memory cache or a data store. The user or computer readable code operating on the user's electronic device designates or assigns a link between a captured data item and a data item in the user's personal data file; enabling the captured data item to carry content categories and processing classes within the personal data file and be assigned a trade parameter or value if they are to be sold, traded, or exchanged.

Many components, sensors, and electronic devices capture data in formats established by consortia of manufacturers or users, by convention, or by unique codecs associated with or implemented by the manufacturer of the component, sensor, or electronic device. To track the origin and properly attribute the format or configuration of a data item, the invention teaches that each captured data item is assigned an identification attribute or “property” or descriptive label to associate the captured data item with a user; and also assigns a “tag” indicating the data generating tool or equipment associated with the electronic device that originated the data. These “tags” can be for a variety of data capture tools or equipment; such as a file creation software product, a keyboard, a mouse, a touch screen, a camera, an audio recorder, a chemical sensor, an electromagnetic sensor, a movement sensor, a location sensor, a pressure sensor, or any of the myriad other electronic components, sensors or devices that may be associated with an electronic device originating data. There may also be intervening computer readable code applied to data to convert it to a data item; to translate or assess the format of the data item; to attribute that format to a standard or formatting convention for that type of data capture tool or sensor; and to tag the originating tool or equipment. The user of the invention can authorize and invoke computer readable code to accomplish the assignment of identification properties and descriptive labels and tags.

The user can also assign a priority level or importance attribute to data items captured from a data generating tool or source such as a file creation software product, a keyboard, a mouse, a touch screen, a camera, an audio recorder, a chemical sensor, an electromagnetic sensor, a movement sensor, a location sensor, a pressure sensor, or by any other data generation tool or source. The assignment of priority levels is particularly important for cases when data is captured and processed and posted in real time, because computer readable code can assign and apply the priority level along with other calculations and formulae to evaluate whether trigger conditions for forward or backward chains of additional computer readable code are to be applied to the data item(s) or initiate server actions.

The trade or exchange value of captured data items associated with a personal data file can be quite variable and can include monetary values and payments, product or manufacturer's coupons, service coupons, rights to access and use a service—such as is current for data coopted by Facebook and Google, rights to access and use physical equipment, rights to view other data, rights to access other data, rights to download other data, rights to download files, and the variety of social rewards and incentives available through social networking sites and providers. Also trade able are the right to access and use a service of a second user and a right to a product sold by said second user.

As the user of the invention identifies a trade able or exchangeable data item or set of data items, the user generates a notification to be sent from his electronic device to a prospective trade partner that includes the terms and conditions for trade or sale or exchange of the data items and inserts a link to a subset of tags labels and category labels within his personal data file or directly appends language that describe the data items. The descriptions may also include categorical, typological, priority, and other features of the data items. Posted into the notification are sufficient contact information about the seller and information options for the prospective trade partner to authorize or provide appropriate links and codes and authentication tools to enable the terms of the exchange to be implemented. Authentication rights on included electronic devices must be authorized by either or both parties and included into conditions and terms. Also posted into the notification are options for the prospective trade partner to indicate whether he will want to access updated versions of the captured data items. Some captured data items will not need to be updated, but the value of other data items might be quite dependent upon their recency, date of capture, or the window of time in which they were captured. The response of the trade partner will include whether and how and when the trade partner will want to arrange transmission of updated versions of the captured data items. If the prospective trade partner responds positively to the notification and selects his trade parameter or payment option, includes his transaction enabling information, and indicates his data item transmission options, the user himself or the electronic device that receives the positive response may send a confirmation of the agreement and the trade parameter for the data items, a confirmation of the transmission option or method selected or indicated by the prospective trade partner, a confirmation of the schedule for transmitting updated versions of the data items, authentication information on the included electronic devices, and a confirmation of the portion or subset of the personal data file that will be transmitted with the data items.

Part and parcel with the agreement to a trade of data items is the expectation that parties to a trade will exchange sufficient financial or other information to enable terms of the agreement to be implemented electronically. If the conditions for the trade have been met, the user of the invention transmits the data items and executes the terms and conditions of the agreement. The trade partner may be a human actor, such as consumer or a social network user, but many other variants of a user are likely in embodiments of the invention, such as a social network service or site, a data federator, a data aggregator, an institution, a business entity, and a governmental agency. Even an electronic device or sensor can act as a trade partner if the electronic device or sensor has access to an algorithm or computer readable code to automate comparisons of the labels of offered data fields against filters or other screens to be applied to data items desired by one trade partner (a buyer) and offered by a second trade partner (a seller). These algorithms or code snippets apply rules regarding processing of the data items and financial exchanges to be implemented according to the conditions and terms for the trade. Whether the trade partner is a person or electronic device, the user is able to adjust trade parameters and transmission schedules and other transactional variables by making changes to the configuration profile and processing rules and forwarding the revisions in a notification to the trade partner for renegotiation or termination of the trading relationship and the terms and conditions that will apply.

The trade partner (buyer) may notify the data seller by email or text or other communication method, or by being enabled to authenticate on the device of the data seller after one or more completed transactions to post a trade parameter for an updated data item as the value of that data item shifts for the trade partner (buyer). This call and response process is easily automated if a trust relationship between the data seller and the trade partner is established.

Embodiments of the invention will include alternatives methods to execute terms and conditions for trades using protected transmission vehicles and methods in order to retain privacy of the data linked to a personal data file. These methods can include use of a virtual private network; data encryption prior to transmission; and use of activation keys to enable a purchaser to access the transmitted data items. Use of protected transmission methods can be sequenced or layered as determined jointly by buyers and sellers of the data items and as technology and options shift in methods and systems to implement ubiquitous computing environments.

The invention is agnostic regarding the physical method for a user to connect his electronic device of to a device of a second user. Wireless signaling methods, the Internet, virtual private networks, intranets, cloud platforms, software as a service sites or any intervening technology that enables data transfer can be implemented. Indeed, it is expected that some embodiments will include computer chips and other hardware specifically configured to implement the method of the invention within what are now called “wearable” computing devices. The invention is operable when a person or a computer chip or processor can be enabled to tag and assign a data item linked to a personal data file to at least one content domain and at least one processing class for transmission to a purchaser or buyer. Alternate indexing and assignment of categories and classes to data items in a personal data file are expected to supplement and enrich the utility and value of the data items in various embodiments of the invention.

An embodiment of the invention illustrating the flexibility of roles for users of the invention is one where the trade partner relationship is that of a donor and a recipient of a donation. The entity that would ordinarily be a seller of data becomes a donor of data. The recipient of the data can be any entity the user (donor) chooses as the trade partner. The trade partner benefits from a richer set of data about the donor from the donor's personal data file as well as incremental transactional—even real time—data regarding actions and activities of the donor. When the trade partner combines the data with that from other users of the invention, the data can be applied to outreach efforts, research, or aggregated for sale to brokers or brand marketers and other entities that have a use for the data. The simple fact of a connection method across the devices of the donor and the trade partner can enable both “push” and “pull” processes to be implemented. The processing class assigned by the donor can include a sub-class for “donate able data items” or an alternate index can include a group of donate able data items. The donor, upon a connection pushes the designated data item within a content domain linked to a processing class or alternate index. Once the connection is established, the trade partner can pull updated data items from any portion or subset of the digital persona of the donor according to assigned rights and rules.

An embodiment of the invention leverages a direct link between devices or sensors of the data buyer and bio-electro-mechanical data of the data seller is use of the data resulting from a trading partnership to cement or leverage the relationship with the user as the seller interacts with any system owned by the buyer of the data. For instance, a restaurant customer who has a trade partnership with a restaurant, upon entering the door of the restaurant can be identified by a bio sensor—perhaps a retinal scanner—and his history of orders and purchases can be posted for the restaurant staff to determine which appetizers or main courses to suggest or whether it is the right time to offer a free “amuse bouche” and so forth. If the same technology is used by a hotel chain, the data can be used by the trading partner—the hotel chain—to automate concierge services, room temperature, stock the in room refrigerator, automate the connection of the patron's wireless devices to the hotel's internet services and so forth.

An embodiment that combines elements of the two embodiments taught above enables the invention to be used to leverage transactions across entities. The donor (the restaurant customer) can designate the trade partner (restaurant) as a middleman or intermediary for a subset of his digital persona to a third party as he pays his bill. The trade partner might offer him a discount. The third party might be a charity or a brand that can leverage the data for their own purposes. Unlike financial exchanges, these data exchanges operate to enable development of relationships. A simple election by a donor to provide his email address to a charity in the course of checking out of a retailer can create the potential for a long term relationship that surpasses a financial donation upon checking out.

An embodiment that is reciprocally advantageous for both partners to the trade is in provision of health services, where the patient offers his data in order for his service provider to be able to assess his health condition through his transferred bio-electro-mechanical data so as to proactively manage his appointments, medications, and other aspects of his health care. The patient gets “right-sized” health services at the right time from a provider who is fully informed of his current health status. Both benefit from increased efficiencies. If the patient elects to function as a donor in this medical context, the social benefit in quality medical data will be enormous.

Another embodiment of the invention will be advantageous for a seller who chooses to expose his entire digital persona, including his intentionally created data files, his personal data file, and his bio-electro-mechanical data, in return for processing by a trading partner's analytic engine and methods. If the trading partner has access to a statistically sufficient number of other digital personas; traits, preferences, interests, competencies, predispositions, and other factors can be compared for purposes of individualized career development, partner selection (match-making), health planning, and other life cycle or life stage coaching and recommendations. The conceptual framework for this embodiment is already in the public domain, but using the data supply chain and the method taught by the invention described herein to make it practical to evolve a trade-able digital persona is original and non-obvious. In this embodiment, the multiplicity of data items—under control of the seller and upon the seller's and the buyer's free and transparent choice to engage in a free market exchange of value enables the requisite relational structure for clarity and equity in what has been a morass of confusion about rights and roles regarding data.

A second embodiment that illustrates the advantage to exposing a digital persona separate from the bio-electro-mechanical captured data items is an embodiment that enables a seller to market his documents and blog posts and other intentionally created files to a buyer with an interest in comparing demographics against the behavior of the originator of the file and the file itself. The documents, videos, and audio files created by persons who witness or participate in an event can be compared with demographic factors to better understand their perspectives on these events over time as well as correlate their bio-data with their behavior in or during those events.

The embodiments describes are illustrative, but by no means exhaustive. When a user or a computer chip substituting for a user can collect and shape data from the digital environment and set up and implement trading parameters for the data, extensive possible embodiments become available to every participant in a data supply chain.

In regard to the figures, FIG. 1 diagrams a set of event sequences related to the capture and processing of an interactive variable. FIG. 1.1 illustrates how the first user invokes the capture and conversion of one or more interactive variables including connecting the device of a first user to a device of a second user, capturing an interactive variable, linking the interactive variable to an algorithm or processer that will convert the variable to a data item, linking the (now) data item to at least one other data item, retaining a record of the linked data items, accepting trading parameters for the data item, and posting a record of the operations and trading parameters upon the captured variable converted to a data item to a data store. FIG. 1.2 identifies the common data capture tools that can be used, but is not a comprehensive list given the expansion of bio-electro-mechanical devices and processors that are being developed. The type of data captured through the data capture tools has also been discussed at some length as data intentionally generated by a user's interaction with file creation software, a user's interaction with electronic devices and sensors, and data generated by sensors and devices associated with a user. FIG. 1.3 points to the assignment of a priority level to a data item as part of the process for determining valuation and positioning the item relative to the set of notifications to be sent to a second user announcing the availability of the data item. FIG. 1.4 illustrates the content and processing parameters for the notification to the second user. These notifications may very well operate as call and response messages and as part of auction or other market and trade analogs where the first user and the second user engage in iterative exchanges until the agreement for terms for the trade is reached. FIG. 1.5 illustrates some of the possible types of trading partners that a first user might elect to negotiate with or donate data items to. It is not an exhaustive list, but is a reasonable indication of the large number of potential trading partners that could function as a second user. FIGS. 1.6 and 1.7 illustrate further the step in the process for negotiating terms. FIG. 1.8 and FIG. 1.9 illustrate that at least one data item included into the trading parameters of an agreement is observed for changes and then transmitted to the second user or trading partner. FIG. 1.10 illustrates that the configuration profile may be changed by the first user. Since the expectation is that the trading of the data is done in a free market environment, the first user is expected to drive the conditions for a trade and therefore might want to reconfigure these. Some embodiments might, however, include long term contracts or agreements that are not subject to reconfiguration without legal or other intervening steps or processes.

FIG. 2 continues the illustration of event sequences with more of a focus on variables involved in transmission and exchange. FIG. 2.1 addresses a few of the many alternatives for insuring the security of the data items themselves through encryption or use of a VPN or secure activation keys in the course of transmission or prior to transmission. FIG. 2.2 a few of the many alternative services that might be used to transmit the data items. FIG. 2.3 is explicated in the art of Ser. No. 14/048,012 and shows how that art integrates with the art of this continuation in part of Ser. No. 14/048,012. FIG. 2.4 and FIG. 2.5 and FIG. 2.6 show how FIG. 1 and FIG. 2 are correlated. FIG. 2.7 illustrates the option intrinsic to the method for a chip or sensor to be pre-configured to operate as a first user.

1. A method comprising a first user instructing an electronic device configured to implement computer readable code to capture at least one interactive variable of said first user as said first user interacts with said electronic device, wherein said first user:
invokes computer readable code to capture upon said electronic device of said first user at least one of said interactive variable;
invokes computer readable code to convert at least one of said captured interactive variable into at least one captured data item in a computer readable format;
accepts from said first user a link of said at least one captured data item to at least one data item in a personal data file of said first user;
invokes computer readable code to post said at least one captured data item linked to at least one data item in a personal data file of said first user to a data store upon said electronic device of said first user;
accepts from said first user assignment of at least one trade parameter for said captured data item linked to said at least one data item linked in a personal data file of said first user; and
posts a record to said data store of said captured data item linked to said personal data file of said first user and said at least one price.

2. The method of claim 1, wherein said at least one captured data item is assigned at least one descriptive label associating said captured data item with use of at least one of a data capture tool, a file creation software product, a keyboard, a mouse, a touch screen, a camera, an audio recorder, a chemical sensor, an electromagnetic sensor, a movement sensor, a location sensor, and a pressure sensor associated with said electronic device of said first user.

3. The method of claim 1, wherein said at least one captured data item is assigned a priority level by said first user associating said captured data item with said use of at least one of said data capture tool, file creation software product, said keyboard, said mouse, said touch screen, said camera, said audio recorder, said chemical sensor, said electromagnetic sensor, said movement sensor, said location sensor, and said pressure sensor associated with said electronic device of said first user.

4. The method of claim 3, wherein a change in a data item assigned said priority level by said first user associating said captured data item with said use of at least one of said data capture tool, file creation software product, said keyboard, said mouse, said touch screen, said camera, said audio recorder, said chemical sensor, said electromagnetic sensor, said movement sensor, said location sensor, and said pressure sensor associated with said electronic device of said first user triggers computer readable code on said electronic device of said first user correlated with said priority level.

5. The method of claim 1, wherein said at least one trade parameter for said captured data item linked to said personal data file is at least one of a monetary value, a coupon for a product, a coupon for a service, a social recognition reward from said second user, a right to access and use a service of a second user, a right to access and use physical equipment owned by said second user, a right to view data in a data store of said second user, a right to download data from a data store of said second user, a right to download a file from an electronic device of said second user, and a right to a product sold by said second user.

6. The method of claim 1, wherein said first user generates upon said electronic device of said first user at least one notification to at least one second user of terms and conditions for at least one of said captured data item linked to at least one data item included in said personal data file for at least one of said price, and wherein said electronic device of said first user implements computer readable code to:
include within said notification said identification attribute of at least one of said captured data item linked to at least one data item included in said personal data file;
include within said notification at least one link to accept transmission of at least one of said captured data item linked to at least one data item included in said personal data file to said electronic device of said second user;
post into said notification by said first user at least one option for transmitting to said electronic device of said second user at least one updated version of said at least one of said captured data item linked to said at least one data item included in said personal data file;
observe by said device of said first user if at least one of said second user is positively responsive to said notification;
accept by said device of said first user an indication of agreement by said at least one of said second user to said price for said captured data item linked to at least one of said data item included in said personal data file;
accept by said device of said first user a selection of said at least one option for transmitting to said electronic device of said second user at least one updated version of said at least one of said captured data item linked to said at least one data item included in said personal data file;
transmit confirmation of said agreement by said first user to said trading parameter for at least one of said captured data item linked to at least one of said data item included in said personal data file to said electronic device of at least one of said second user;
implement said at least one option for transmitting said at least one updated version of said at least one of said captured data item linked to at least one of said data item included in said personal data file to said electronic device of at least one second user;
configure by said first user a schedule for transmitting at least one updated version of said at least one of said captured data item linked to at least one of said data item included in said personal data file from said electronic device of said first user to said electronic device of at least one of said second users;
transmit at least one of said captured data item linked to said at least one of said data item included in said personal data file from said data store of said first device to a device of at least one second user in accord with said agreement and said schedule for transmitting at least one updated version of said at least one of said captured data item linked to at least one of said data item included in said personal data file to a device of at least one of said second users; and
execute said terms and conditions of said agreement.

7. The method of claim 1, wherein said first user designates said at least one of said second user as a recipient of at least one of said captured data item linked to at least one of said data item included in said personal data file; and wherein said one or a plurality of second user is at least one of a consumer, a social network user, a data federator, a data aggregator, an institution, a business entity, and a governmental agency.

8. The method of claim 1, wherein said electronic device of said first user loads a configuration profile to accept changes to one or a plurality of captured data items linked to a data item within said personal data file, for said trading parameter for said at least one of said captured data item linked to said personal data file transmitted to said second user, for scheduling transmission of said at least one said captured data item linked to at least one of said data item included in said personal data file, and for executing said terms and conditions of said agreement between said first user and said second user.

9. The method of claim 1, wherein at least one second user is enabled to authenticate upon the device of said first user to download at least one of said captured data item linked to at least one of said data item included in said personal data file of said first user.

10. The method of claim 1, wherein computer readable code on said electronic device of at least one second user downloads at least one of said captured data item linked to at least one of said data item included in said personal data file to said electronic device of at least one of said second user.

11. The method of claim 1, wherein said execution of said terms and conditions uses protected transmission vehicles and methods to retain privacy of said at least one data item linked to said personal data file, said methods including:
use of a virtual private network;
encryption prior to transmission; and
use of at least one activation key to open said data item linked to said personal data file.

12. The method of claim 1, wherein said first user connects said electronic device of said first user to said electronic device of a second user using at least one of the Internet, a virtual private network, an intranet, a cloud platform, and a software as a service site.

13. The method of claim 1, wherein said first user invokes computer readable code upon said electronic device of said first user to tag and assign at least one of said data item linked to said personal data file to:
one or a plurality of content domain in at least one of said personal data file of said first user;
one or a plurality of said processing classes in at least one of said personal data file of said first user; and
one or a plurality of alternate indexes in at least one of said personal data file of said first user.

14. The method of claim 1, wherein said first user is a computer processer configured implement at least one algorithm to perform the functions of said first user on said electronic device configured to process computer readable code.

15. The method of claim 1, wherein at least one second user is enabled to authenticate upon the device of said first user to post an offer of a trading parameter for said data item upon said data item being changed.
